(19) United States
(12) Patent Application Publication
(10) Pub. No.: US 2026/0096661 A1
(43) Pub. Date: Apr. 9, 2026

(54) MODULAR BENCH ASSEMBLIES FOR OUTDOOR RECREATIONAL AREAS

(71) Applicant: Victor Stanley, LLC, Dunkirk, MD (US)

(72) Inventors: Ryan Gaets Orr, Easton, MD (US); Alec Todd, Auburn, AL (US); Thomas R. Norquist, Fort Payne, AL (US); Emma Skalka, Dunkirk, MD (US)

(21) Appl. No.: 19/344,747

(22) Filed: Sep. 30, 2025

Related U.S. Application Data
(60) Provisional application No. 63/703,680, filed on Oct. 4, 2024.

(51) Int. Cl. A47C 13/00; A01G 9/02; A47B 83/02; A47C 1/14; A47C 7/62; A47C 11/00

(52) U.S. Cl. CPC A47C 13/005; A47C 1/14; A47C 7/624; A47C 11/005; A01G 9/0302; A47B 83/02

(57) ABSTRACT

Modular components which enable the formation of customized outdoor bench assemblies may include any combination of straight seat components, angled seat components and/or angled end seat components, backrest components, leg components, planter components, and coffee/side table components. These modular components can be assembled together in any of a variety of different manners to form an almost limitless number of different seating solutions.

The present invention claims priority to United States Provisional Ser. No. 63/703,680 , filed on Oct. 4, 2024, the entirety of which is incorporated by reference herein.

### SUMMARY OF THE INVENTION

The present disclosure is directed to a set of modular components that provides a landscape designer with an almost endless number of options to create bench assemblies having different seating options and, in some embodiments planting and/or side table, arrangements. Using the modular bench components described herein, bench sections can be arranged and attached together in a variety of ways to produce unique and custom seating arrangements.

Embodiments of the present disclosure are directed to modular outdoor bench assemblies that include at least a seat component, a backrest component, and a leg component, one or more—and typically a plurality—of which may all be linked together to produce any of a variety of different seating arrangements.

The seat component has an upper seating surface and an underside, each of which spans between a first end and a second end. The underside of the seat component includes a plurality of backrest mounting brackets. The plurality of backrest mounting brackets may be positioned at each of the first end and the second end, between the first end and the second end, or a combination thereof. The plurality of backrest mounting brackets may be configured and used to attach the backrest component to the seat component. The underside of the seat component may also include an end support mounting bracket positioned at each of the first end and the second end. The end support mounting bracket may be configured and used to attach the leg component and, in some embodiments, a planter/table component.

The backrest component comprises a front face and a rear face. The backrest component is configured to be affixed to at least two of the backrest mounting brackets by braces, each brace having a first end that is attachable to the rear face of the backrest component and a second end that is attachable to one of the backrest mounting brackets on the underside of the seat component. The braces may be angled or curved so as to extend between the rear face of the backrest and the underside of the seat component.

The leg component comprises first and second legs and an upper surface. The upper surface may be configured to serve as an armrest. The leg component is configured to be affixed to one of the end support mounting brackets that are positioned at the first and second ends of the seat component. For instance the leg component may include a mounting bracket, which may extend between the first and second legs and be positioned below the upper surface, that is secured to the end support mounting bracket of the seat component, e.g. by one or more fasteners passing through aligned apertures. In some embodiments, the leg component may also be secured to the underside of the seat component via an additional stabilization attachment. For instance, a stabilization bracket may extend from the mounting bracket of the leg component, e.g. substantially centrally between the first and second legs, and may be secured to a corresponding stabilization bracket located on the underside of the seat component. In some embodiments, at least one and optionally each of the legs of the leg component are configured to be secured to a ground surface by one or more fasteners.

In some embodiments, the assembly may include a plurality of different backrest components. For instance, the assembly may include a first backrest component and a second backrest component. The first and second backrest components may each include a front face and a rear face and be configured to be affixed to at least two of the backrest mounting brackets by braces as described above. The primary difference between the first and second backrest components may be in the length of each component, with the length of the second backrest component being different from the length of the first backrest component. In some embodiments, for instance, the first backrest component may have a length that is substantially equivalent to the length of the seat component and the second backrest component may have a length that is half or less than half the length of the first seat component.

In some embodiments, the assembly may also include a component that operates as a planter, a table, or a combination thereof. The planter and/or table component (as it will be referred to herein) may be configured to be affixed to one of the first and second ends of the seat component, e.g. in place of the first leg component. For instance, the planter and/or table component may, like the leg component have an upper surface that may serve as an armrest and a mounting plate positioned below the upper surface that is configured to be secured to the end support mounting bracket of the seat component, e.g. by one or more fasteners passing through aligned apertures, in substantially the same manner as the leg component. More particularly, the planter and/or table component may include a top surface and a plurality of mounting plates positioned below the top surface, each of the plurality of mounting plates running along a side of the planter and/or table component and being configured to be affixed to an underside of the seat component at the first end or the second end of the seat component.

In some embodiments, for instance, the planter and/or table component may have four sides, all of which are configured to be affixed to the first end or the second end of a seat component. For example, the planter and/or table component may have a square shape when viewed from above. In this manner, the planter and/or table component may serve as an end component for multiple bench components, linking multiple bench components together in a variety of different orientations, e.g. facing away from one another at a 90 degree angle as shown in FIG. 1, facing toward one another at a 90 degree angle, or being aligned with one another, e.g. as shown in FIG. 17.

As with the leg component, the planter and/or table component may have legs. In some embodiments, at least some of the legs, optionally each of the legs, are configured to be secured to a ground surface by one or more fasteners.

In some embodiments, the assembly may include a plurality of different seat components. In some embodiments, for example, the assembly may include a first seat component that extends linearly between the first end and the second end and a second seat component has an angular portion between the first end and the second end. In some embodiments, for example, the second seat component may have an angular portion that forms an angle of about 90 degrees or an angular portion that forms an angle of about 120 degrees. In some embodiments, the assembly may include one or more linear seat components and one or more angular seat components. For instance, the assembly may include a first linear seat component, a second angular seat component that forms an angle of about 90 degrees, and a third angular seat component that forms an angle of about 120 degrees. In other embodiments, the assembly may include seat components that are straight but which have at least one angled end. In such embodiments, the angled ends of those straight seat components can be arranged adjacent one another to form an angled bench portion, e.g. one having an angle of about 90 degrees or one having an angle of about 120 degrees, without requiring an angled seat component.

In some embodiments, the assembly may also include one or more armrest components. Each of the one or more armrest components may be configured to be attached to a seat component so as to extend upward from the seating surface. In some embodiments, the armrest component may be configured to be attached to a seat component at a midpoint between the first end and the second end, thereby dividing the seat component into first and second seats.

In some embodiments, the upper seating surface of each seat component may include a plurality of plastic slats, a front face of each of the one or more backrest components may include a plurality of plastic slats, or both. Similarly, in some embodiments, the sidewalls of the planter and/or table component may each comprise a plurality of plastic slats. An example assembly with plastic slats in place on the seat components, backrest components, and planter and/or table component is shown in FIGS. 15-16.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is a top, front perspective view of an exemplary embodiment of a modular outdoor bench assembly of the present disclosure showing a variety of components—seat components, backrest components, leg components, a planter component, and armrest components, arranged and secured together to form an example seating arrangement.

FIG. 2 is a bottom, front perspective view of the assembly shown in FIG. 1.

FIG. 3 is a bottom, rear perspective view of the assembly shown in FIG. 1.

FIG. 4 is a bottom, rear perspective view of a portion of the assembly shown in FIG. 1, showing the attachments between (a) leg components and seat components, (b) a planter component and seat components, and (c) backrest components and seat components.

FIG. 5 is a top perspective view of a first seat component of an embodiment of an assembly of the present disclosure.

FIG. 6 is a bottom perspective view of the seat component shown in FIG. 5.

FIG. 7 is a side perspective view of a leg component of an embodiment of an assembly of the present disclosure.

FIG. 8 is a side perspective view of a framework for an embodiment of a planter and/or table component of an embodiment of an assembly of the present disclosure.

FIG. 9 is a side perspective view of a framework for an embodiment of a planter component of an embodiment of an assembly of the present disclosure.

FIG. 10 is a partially exploded side perspective view of the framework for the embodiment of a planter component shown in FIG. 9.

FIG. 11 is a side perspective view of a framework for an embodiment of a table component of an embodiment of an assembly of the present disclosure.

FIG. 12 is a partially exploded side perspective view of the framework for the embodiment of a table component shown in FIG. 11.

FIG. 13 is a top perspective view of an embodiment of a non-linear seat component having an angular portion that forms a 120-degree angle.

FIG. 14 is a top perspective view of embodiments of seat components that have a first end, a second end, or both that is angled rather than perpendicular to the front and rear edges of the seat component.

FIG. 15 is a front, left perspective view of an embodiment of a modular outdoor bench assembly of the present disclosure showing a variety of components—seat components, backrest components, leg components, and a planter component, arranged and secured together to form a example seating arrangement.

FIG. 16 is a front, right perspective view of the assembly shown in FIG. 15.

FIG. 17 is a front, perspective view of two different outdoor bench assemblies that can be assembled from the same set of seat components, backrest components, leg components, and a planter component.

FIG. 18 is a perspective view of a square bench assembly that can be assembled from modular components of the present disclosure.

FIG. 19 is a perspective view of a hexagonal bench assembly that can be assembled from modular components of the present disclosure.

FIG. 20 is a front, perspective view of another exemplary outdoor bench assembly that can be assembled from a modular set of components as described herein.

FIG. 21 is an illustration of an exemplary set of modular components according to an embodiment of the present disclosure.

### DETAILED DESCRIPTION OF THE INVENTION

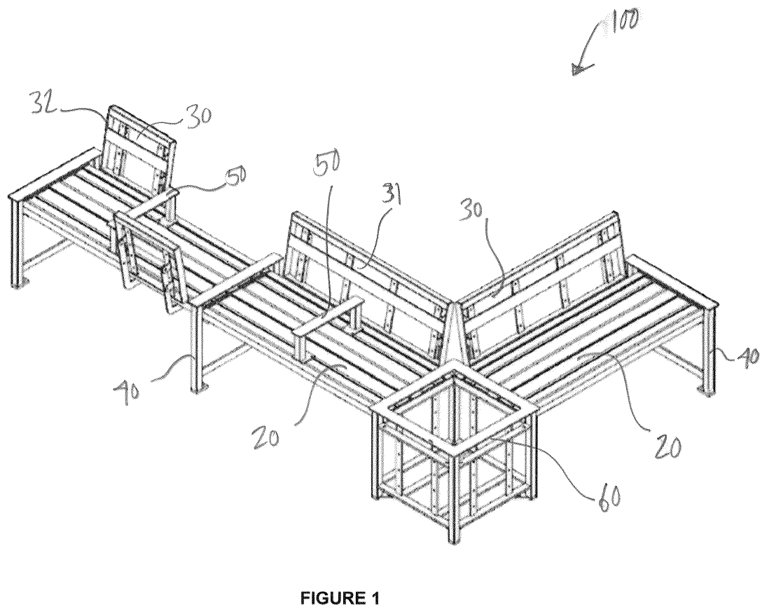

An example modular outdoor bench assembly 100 is shown in FIGS. 1-4. The assembly 100 is assembled from a set of modular components, which in this embodiment includes: seat components 20, backrest components 30, leg components 40, armrest components 50, and a planter and/or table component 60. As explained herein, all of the components 20, 30, 40, 50, 60 of this assembly 100 can be arranged and secured together in a variety of different manners to provide different customized seating arrangements. Accordingly, the arrangement/orientation of the components shown in FIGS. 1-4 is meant to be exemplary of just one of many potential arrangements.

In other embodiments, one or more of the modular components 20, 30, 40, 50, and 60 may be omitted from the set of modular components that can be used to form various bench assemblies. In some embodiments, for instance, armrest components 50 may be omitted. In some embodiments, backrest components 30 may be omitted. In some embodiments, planter and/or table components 60 may be omitted. Similarly, in some embodiments, the set of modular components may include additional components without departing from the scope of the present invention.

The set of modular components that can be used to create a variety of bench seating assemblies also includes one or more different types of modular seat components 20.

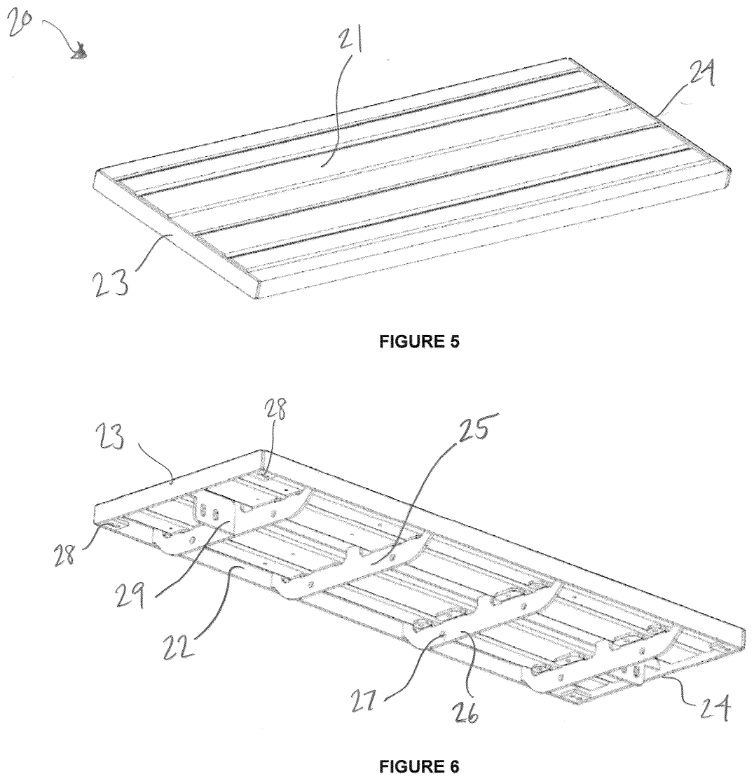

An example of a modular seat component 20 is shown in FIGS. 5-6. The seat component has an upper seating surface 21 and an underside 22, each of which spans between a first end 23 and a second end 24. The upper seating surface 21 may be formed of any of a variety of known bench surface materials, including e.g. wooden slats, plastic slats, or the like. The underside 22 of the seat component includes a plurality of backrest mounting brackets 25. The plurality of backrest mounting brackets 25 may be positioned at each of the first end 23 and the second end 24, between the first end and the second end, or a combination thereof. The plurality of backrest mounting brackets 25 may be configured and used to attach one or more backrest components 30 to the seat component, e.g. by braces as described herein.

The backrest mounting brackets 25 may each comprise a plate 26 that extends downward from the underside of the seat component and spans substantially a width of the seat component between a front edge and a rear edge. Each backrest mounting component 25, e.g. each plate 26, may comprise a plurality of apertures 27 that are configured to receive fasteners in order to secure a brace having aligned apertures thereto. In some embodiments, the plate 26 and apertures 27 may be configured to allow the mounting of a backrest component 30 so that it extends from either the front edge or the rear edge. In this way, a seat component 20 may be configured so that it cannot be positioned in the wrong direction, as the front or rear of the component can be determined when installing one or more backrest components 30.

In the illustrated embodiment, the seat component 20 comprises four backrest mounting brackets 25, although seat components having different lengths may comprise greater or fewer backrest mounting brackets as may be desired or needed to support a backrest component 30 of desired length and/or multiple backrest components. In other embodiments, for instance, the number and/or arrangement of backrest mounting brackets 25 may vary from that shown and described herein.

As shown in the assembly 100 illustrated in FIGS. 1-4, the backrest mounting brackets 25 may be used to attach any of a variety of different backrest components 30, such as for example either a first backrest component 31 that has substantially the same length as the seat component 20 (e.g. thereby producing a seating location for multiple people) or a second backrest component 32 that has a length that is equal to or less than half the length of the seat component (e.g. thereby producing a seating location for a single person). In such an arrangement, the second backrest component 32 may be positioned in one of three different positions—a first side position in which it is mounted to the first and second mounting brackets (starting from the first end), a central position in which it is mounted to the second and third mounting brackets, and a second side position in which it is mounted to the third and fourth mounting brackets. Additionally, multiple of the second backrest components 32 may be attached to a seat component 20, e.g. in any combination of the above such as one in the first side position and another in the second side position. Moreover, as shown in FIG. 1 for example, one of the second backrest components 32 can be mounted so as to extend from a rear side of a seat component 20 and another of the second backrest components can be mounted so as to extend from a front side of a seat component, thereby forming seats that face in two opposing directions. In other embodiments, however, the set of modular components—and hence the assemblies created therefrom—may contain more or fewer backrest components 30, e.g. some sets may only contain a single backrest component or none at all.

The underside 22 of the seat component 20 may also comprise one or more apertures 28 adjacent either or each of the first end 23 and the second end 24. As will be described later, these apertures 28 may be configured and used to secure the seat component to a leg component 40. As in the embodiment of a seat component 20 illustrated in FIG. 6, the underside 22 of the seat component may include two apertures 28 positioned adjacent each end 23, 24, a first at the corner formed between the end and the front edge and a second at the corner formed between the end and the rear edge of the seat component. Other numbers and/or configurations of apertures 28 are also contemplated without departing from the scope of the present disclosure.

The underside 22 of the seat component 20 may also comprise one or more stabilizer brackets 29 adjacent either or each of the first end 23 and the second end 24. As will be described later, the one or more stabilizer brackets 29 may be configured and used to further secure the seat component to a leg component 40. As in the embodiment of a seat component 20 illustrated in FIG. 6, the underside 22 of the seat component may include a single stabilizer bracket 29 positioned at a substantial midpoint between the front edge and the rear edge of the seat component (and also substantially centrally between the apertures 28) at each of the first end 23 and the second end 24. Other numbers and/or configurations of stabilizing brackets 29 are also contemplated without departing from the scope of the present disclosure.

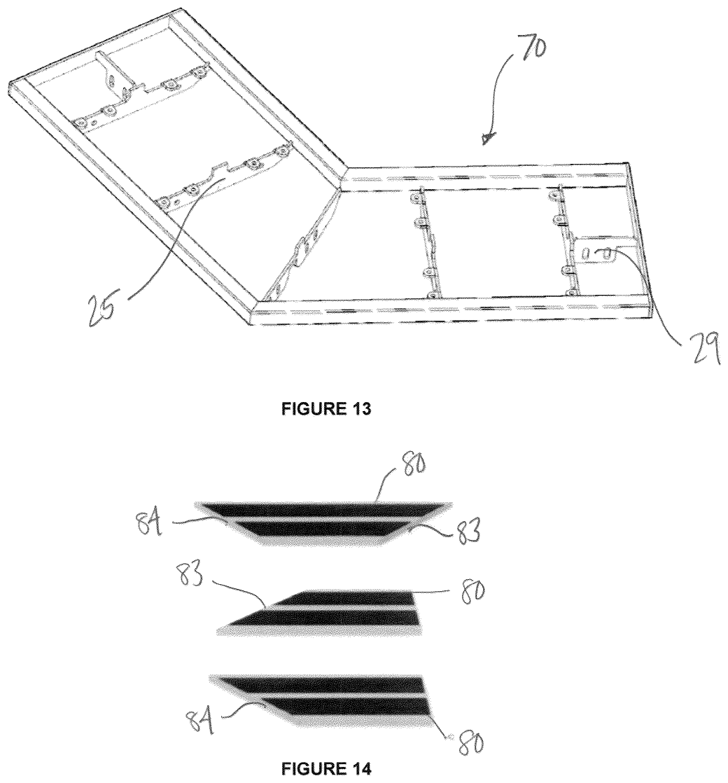

Additional, optional, non-linear seat components 70 are shown in FIG. 13, though the material that forms the actual seating surface, e.g. plastic slats, is not shown in FIG. 13. By including angular seat components such as those shown in FIG. 13, embodiments of the modular components of the present disclosure may provide a designer with an even greater variety of options for customized and unique seating arrangements. Though the non-linear seat component 70 shown in FIG. 13 forms a 120-degree angle, other non-linear seat components that form different angles, including for example one that forms a 90-degree angle, are also contemplated.

Alternatively to non-linear seat components 70, seat components 80 that have a first end 83, a second end 84, or both that is angled rather than perpendicular to the front and rear edges of the seat component may be provided. In some embodiments, the first end 83, the second end 84, or both may be angled for instance at an angle of about 45-degrees (such that two such angled surfaces may be combined to create a 90-degree turn in the resulting bench), at an angle of about 60-degrees (such that two such angled surfaces may be combined to create a 120-degree turn in the resulting bench), etc. In some embodiments, these seat components 80 may be assembled together to form non-linear seat components similar to those described above. Where one of the first end 83 and the second end 84 is perpendicular to the front and rear edges of the seat component 80, that end may be attached (e.g. through a leg component 40) to a non-angled end of any other bench component 20, 70, 80. Embodiments of these angled-end(s) seat components 80 are shown in FIG. 14.

By assembling these non-linear seat components 70 or angled-edge seat components 80 together with one another and/or with straight seat components 20, one may form bench assemblies that offer a continuous or a substantially continuous seating surface (which may be interrupted by legs and/or arm rests) that forms any of a variety of angles. This provides an outdoor space designer with a massive variety of possible bench assembly, and thus seating, configurations.

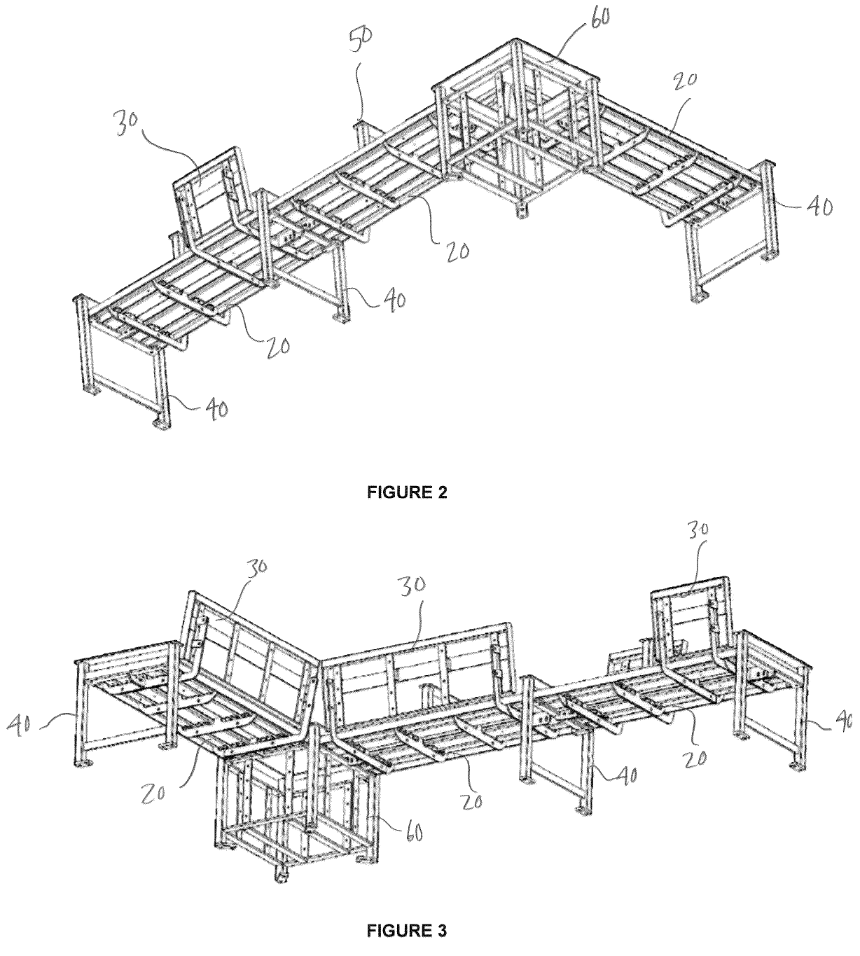

The set of modular components that can be used to create a variety of bench seating assemblies may also include one or more backrest components 30. The backrest components 30 may include a front face that is made up of the same materials as the upper seating surface 21, e.g. wooden slats, plastic slats, or the like. The rear face of the backrest components may comprise mounting elements, shown in FIGS. 2-4 as mounting tabs 33 by which backrest mounting brackets 35 can be secured. As shown in the illustrated assembly 100, those mounting tabs 33 may be positioned at each end of the backrest component. For stability, it may also be desirable to have more than one mounting tab 33 at each end—in the illustrated embodiment for instance two mounting tabs are located at each end of the backrest component 30.

A backrest component 30 may be secured to a seat component 20 through substantially “L” shaped brackets 35. These substantially “L” shaped brackets have an upper arm 36 that extends (substantially vertically) along a rear face of a backrest component and is mounted to the mounting tab(s) 33 positioned on the rear face of the backrest component, and a lower arm 37 that extends (substantially horizontally) along an underside 22 of a seat component and is mounted to one of the backrest mounting brackets 25 positioned on the underside of the seat component. As is shown in the illustrated assembly, it is desirable that each backrest component 30 be secured to a seat component 20 via at least two of the substantially “L” shaped brackets 35, e.g. one near each end of the backrest component, for stability. A particularly long backrest component 30 however may require more than two brackets 35 or a particularly short backrest component may require only a single bracket for adequate stability.

The set of modular components that can be used to create a variety of bench seating assemblies also includes one or more different types of leg component 40.

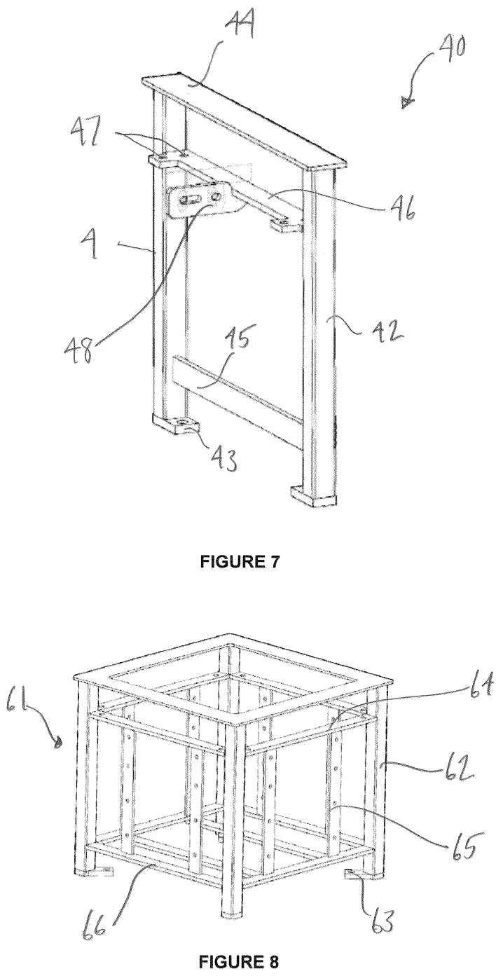

An example of a leg component 40 is shown in FIG. 7. The leg component 40 includes a first leg 41 and a second leg 42, each of which may include a bottom plate element 43 that is configured to be attached to an outdoor surface, e.g. through one or more concrete fasteners or the like. Spanning between the legs 41, 42 may be a top element 44, which is configured to serve as an armrest, one or more stabilization elements 45, and a mounting plate 46. As can be seen in FIG. 7, the mounting plate 46 may have projections that contain apertures 47 at each end, adjacent to the first and second legs 41, 42. These apertures 47 are configured to align with apertures 28 at either end of a seat component 20 for securement thereto, e.g. by conventional fasteners such as bolts or the like. The leg component 40 may also include a stabilizer element 48 that extends from the mounting plate 46, e.g. at a substantial midpoint between the first and second legs 41, 42 and which is configured to be secured to a stabilization bracket 29 (shown in broken line in FIG. 7) present on the underside 22 of the seat component 20, e.g. by conventional fasteners such as bolts or the like.

The combination of the securement of a seat component 20 and a leg component 40 by (a) fasteners passing through the apertures 47 on the mounting plate 46 of the leg component 40 and apertures 28 on the underside of the seat component and (b) one or more fasteners passing through an aperture on the stabilizer element 48 of the leg component and stabilization bracket 29 on the underside of the seat component, provides a strong and stable attachment between the seat component and the leg component and prevents wobbling.

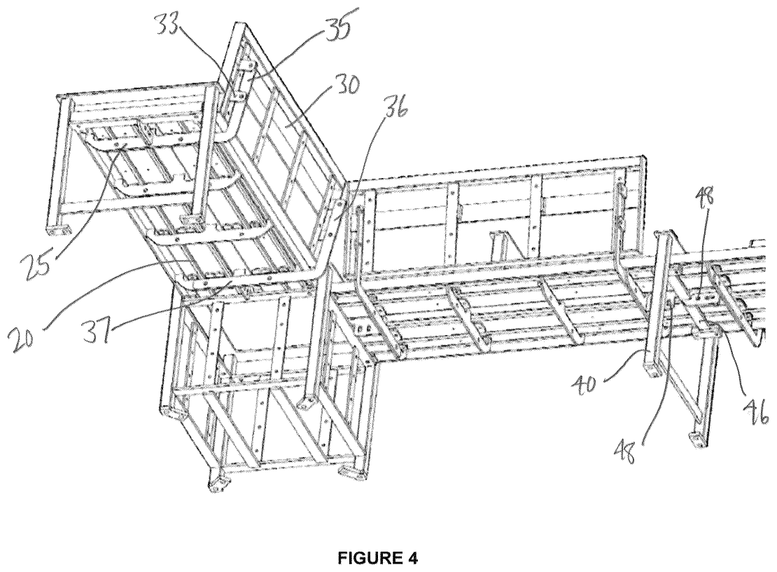

Some leg components 40 may be configured to be attached to a single seat component 20, e.g. to serve as an end of a seating surface (as for example at either end of the assembly shown in FIGS. 1-4). Other leg components 40 may be configured to be attached to two seat components 20, e.g. to support a seating surface at a point within its span (as for example the leg component positioned in the middle of two seat components in the assembly shown in FIGS. 1-4). In such an embodiment, the mounting plate 46 may comprise projections having apertures 47 that extend in both directions and optionally a stabilizer element 48 (or stabilizer elements) that projects in both directions, e.g. as can been seen in FIG. 4.

Some leg components 40 may be configured to designate the end of a seating area or to separate adjacent seat components 20 into independent seating areas by way of a top element 44, which as shown in the embodiment illustrated in FIGS. 1-4, may be configured to serve as an armrest. Other leg components 40, however, may not include the top element 44 and may instead be configured to be positioned entirely below the seat component(s) 20 to which they are attached. In this way, a leg component 40 may support a continuous seating surface without introducing any dividers. In such embodiments, the mounting plate 46 may be positioned at the top of the leg component 40.

In some embodiments, the set of modular components may also include an armrest component 50 that is independent from a leg component 40, an example of which is shown in the assembly 100 illustrated in FIGS. 1-4. The armrest component 50 may have plates at each end that are configured to receive fasteners which also pass between slats of the seating surface and are secured to the underside 22 of a seat component 20.

The set of modular components that can be used to create a variety of bench seating assemblies may also include one or more planter and/or side table components 60. An example of a framework 61 for a planter and/or table component 60 is shown in FIG. 8. The framework 61 comprises at least four legs 62, each of which is positioned in a corner, thereby forming a square. As with the leg components 40, each of the four legs 62 may include a bottom plate element 63 that is configured to be attached to an outdoor surface, e.g. through one or more concrete fasteners or the like. Also, similar to the leg components 40, the framework 61 may also include one or more mounting plates 64 which span between and connect adjacent legs 62. As can be seen in FIG. 8, the mounting plate 64 has apertures at each end, adjacent to each leg 62. These apertures are configured to align with the apertures 28 at either end of the underside 22 of a seat component 20 for securement thereto, e.g. via a conventional fastener such as a bolt or the like. In contrast to the leg component 40, and due to the size and dimensions of the planter and/or table component 60, no additional stabilizers are needed to ensure a stable connection between the planter and/or table component and the seat component 20.

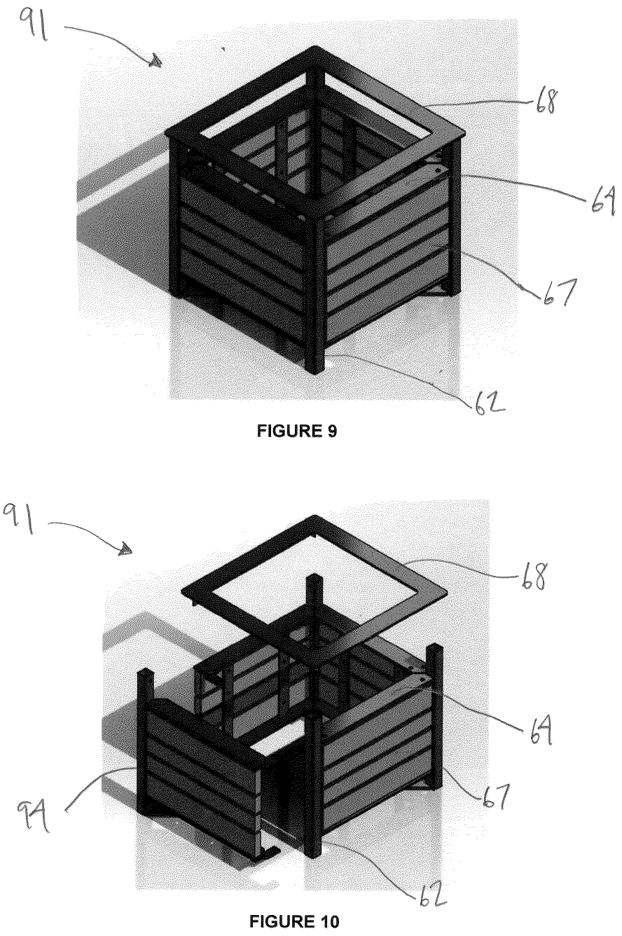

The framework 61 may also include one or more side panel mounting components 65, by which one or more side panel elements may be attached to the framework. In some embodiments, the side panel mounting components may extend downward from the mounting plate 64. As shown in FIGS. 9-12, for example, the mounting plates 64 may form or correspond with an upper edge of the side panels 67. As shown in the embodiment illustrated in FIG. 8, the framework 61 may also comprise one or more stabilizing bars 66 which span between adjacent legs 62 and provide additional structural stability. The side panel mounting components 65 may, in some embodiments, span upward from the stabilizing bars 66. As shown in FIGS. 9-12, for example, the stabilizing bars 66 may form or correspond with a lower edge of the side panels 67. In some embodiments, the side panel elements 67 may comprise a surface, e.g. slats, that corresponds to the seating surface of the seat components 20 and the front face of the backrest components 30, such as is shown in FIGS. 9-12 and 15-16.

The planter and/or side table component 60 may be configured to operate as a planter 91 or a side table 92 depending on which top element is provided.

FIGS. 9-10 for example show a framework 61 with the side panels 67 attached and which includes a planter top component 68. The planter top component 68 is in the shape of a square having a central opening into which a planter base can be positioned, the planter base containing soil and plants, e.g. flowers, that extend through the central opening for instance. The planter top component 68 may also serve as an armrest for the seat component(s) 20 that are mounted thereto. Moreover, the central opening may be sized as desired, e.g. in some embodiments the planter 91 may have a wider ledge and a smaller central opening than that shown in FIGS. 9-10. The planter top component 68 may be attached to the top of each leg 62 of the framework 61 through a conventional attachment, as would be understood by persons skilled in the art.

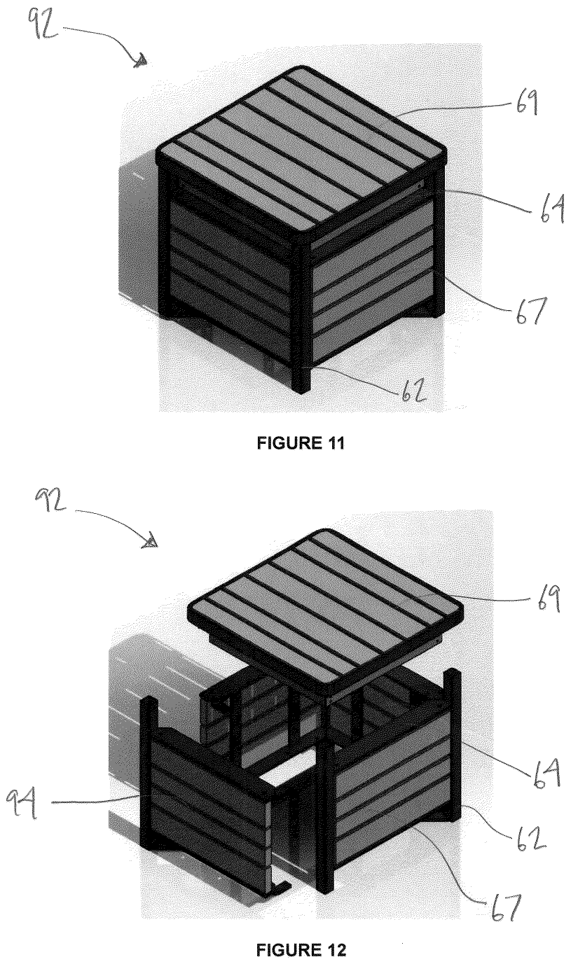

FIGS. 11-12 for example show a framework 61 with the side panels 67 attached and which includes a table top component 69. The table top component 69 too is in the shape of a square but with no central opening. As shown in the illustrated embodiment, the table top component may instead have a top surface that corresponds with the seating surface of the seat components 20 and the front face of the backrest components 30. In other embodiments, the top surface may have a different appearance, e.g. as may be desired for a particular assembly or installation. The table top component 69 may be attached to the top of each leg 62 of the framework 61 through the same conventional attachment as the planter top component 68, as would be understood by persons skilled in the art.

FIGS. 10 and 12 also show an embodiment in which the planter and/or side table component 60 is, itself, made up of components that are designed to provide improved modularity. Rather than having to ship an entire square structure, which is the case where the framework 61 is welded together, for instance, the framework 61 and side panels 67 may be shipped as four separate, substantially flat, side elements 94 which may assembled with either a planter top component 68 or a table top component 69 on-site to form the planter or side table component 60. Moreover, each of the side elements 94 may be identical or substantially identical, thereby reducing costs and facilitating assembly.

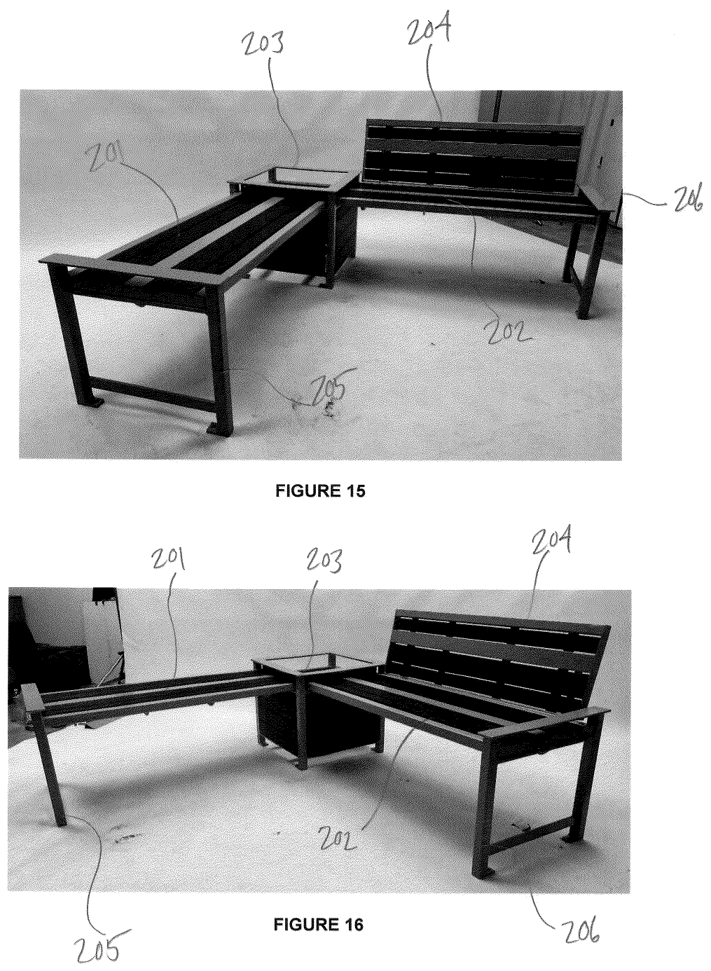

By utilizing a set of modular components such as those described herein, one can create customized bench seating for any space. In addition to the assembly 100 shown in FIGS. 1-4, another embodiment of a bench assembly 200 that can be prepared is shown in FIGS. 15-16. As shown there, a first seat component 201 and a second seat component 202 are linked together via a planter component 203. The first seat component 201 has no backrest, whereas the second seat component 202 is provided with a backrest component 204 that spans the entire length of the second seat component. A first leg component 205, with an armrest, is positioned at the end of the first seat component 201 opposite the end that is mounted to the planter component 203. A second leg component 206, with an armrest, is positioned at the end of the second seat component 202 opposite the end that is mounted to the planter component 203. Because of the modular nature of the assembly 200, any of a variety of additional components could be added to the assembly or components could be removed from the assembly as desired due to changing site characteristics.

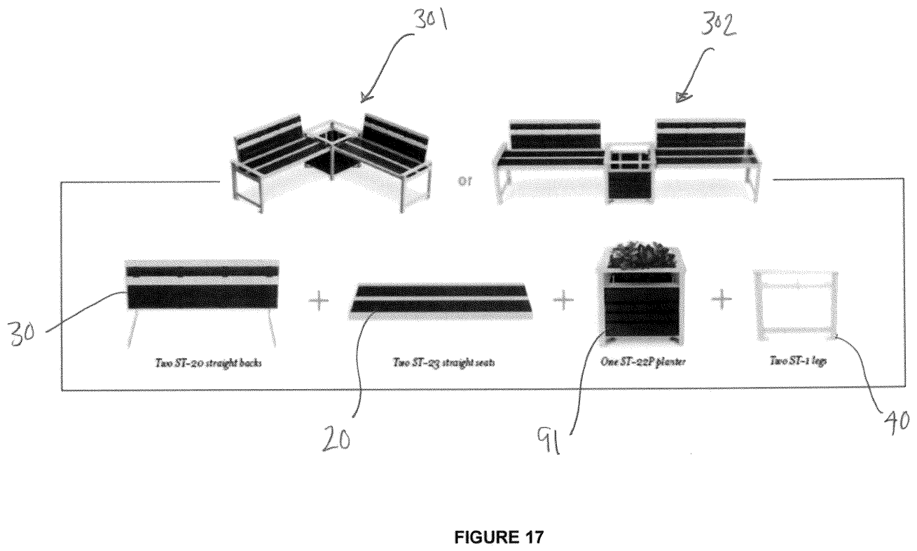

FIG. 17 shows two different assemblies 301, 302 that can be prepared from the same set of modular components, namely, two backrest components 30, two straight seat components 20, one planter component 91, and two leg components 40. By simply replacing the planter component 91 with either a third leg component (which could be attached to both of the seat components) or with an angled seat component 70 or angled-edge seat components 80 and additional leg components, moreover, one could create a completely different assembly. Moreover, additional components could be added to create a “closed” assembly in which no free ends exist.

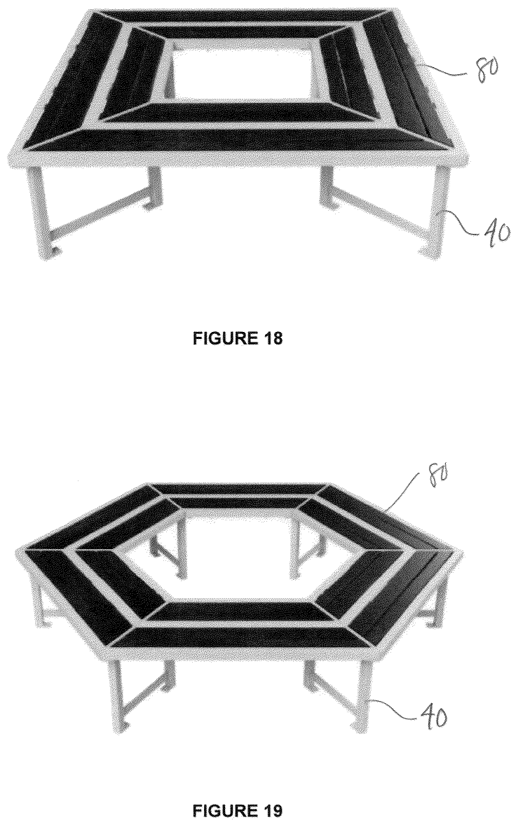

For instance, some examples of “closed” assemblies that can be formed by a plurality of non-linear seat components 70 or angled-edge seat components 80 are shown in FIGS. 18-19. As illustrated, these non-linear seat components 70 or angled-edge seat components 80 may be assembled together to create benches having polygonal shapes. Although these assemblies are shown as providing a continuous seating surface, e.g. through the use of leg components 40 that do not extend above the upper surfaces of the seat components, leg components 40 that include armrests may also be utilized at any number of component linkages to instead create a substantially continuous seating surface that is divided into independent seating zones.

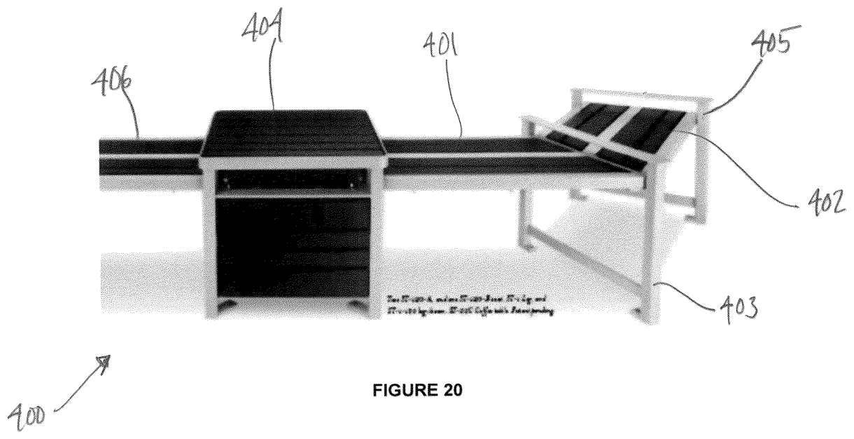

FIG. 20 shows an assembly 400 in which two angled-edge seat components 401, 402 are connected together, with a first leg component 403, to form a bench having an angle of 120 degrees. The opposite end of the first angled-edge seat component 401 (which is a straight end) is mounted to a table component 404. The opposite end of the second angled-edge seat component 402 (which is a straight end) is supported by a second leg component 405. A third seat component 406 can be seen extending from the opposite side of the table component 404. As with all the assemblies shown herein, assembly 400 is just one example of the variety of different custom seating assemblies that can be created using a set of modular components such as those described herein.

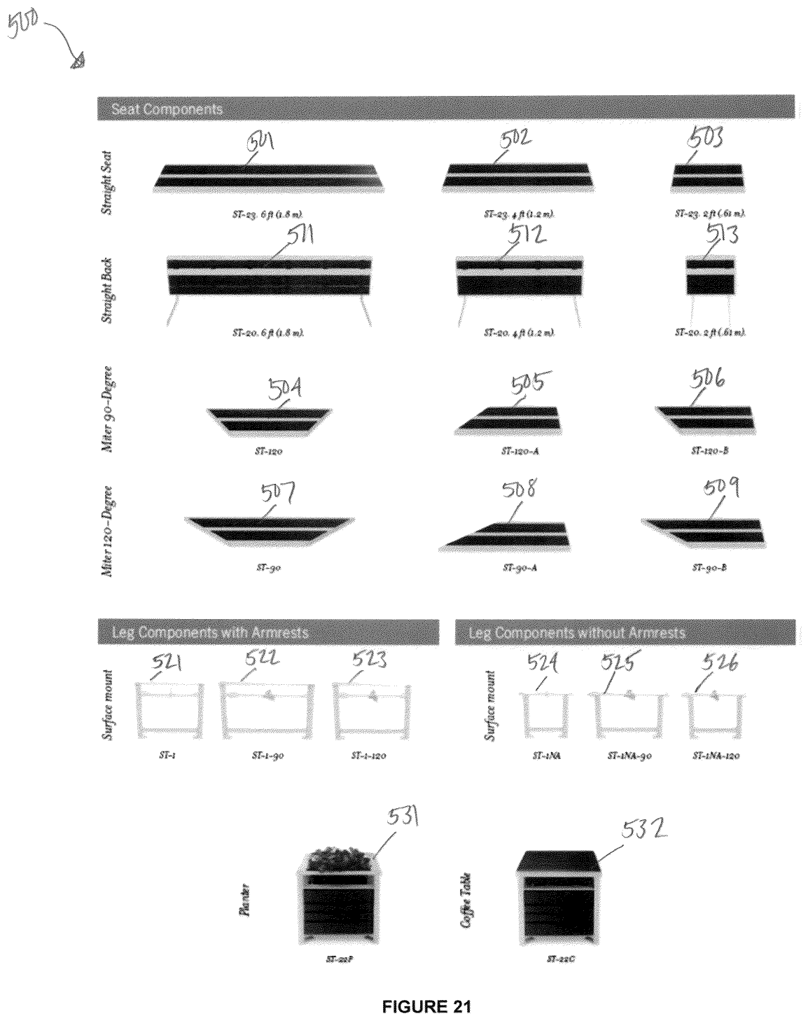

FIG. 21 shows an example of a set of modular bench components 500 according to an embodiment of the present disclosure. That illustrated set of modular components 500 comprises linear seat components of three different sizes 501, 502, 503 as well as backrest components configured for use with each of those different sized seat components 511, 512, 513. It also include angled-end seat components 504, 505, 506 that are configured to produce a bench with a seating surface that forms a 120 degree angle as well as angled-end seat components 507, 508, 509 that are configured to produce a bench with a seating surface that forms a 90 degree angle. Finally, it includes a first set of leg components 521, 522, 523 that include armrests and a second set of leg components 524, 525, 526 that do not include armrests. Note that one of the leg components from each set 521, 524 is configured for connection to a straight end of a seat component, whereas the other two leg components from each set 522, 525 and 523, 526 are configured for connection to a 90 degree angle formed by the angled ends of adjacent angled-end seat component or a 120 degree angle formed by the angled ends of adjacent angled-end seat components. Finally, it includes a planter component 531 and a coffee table component 532, each of which make use of the same framework and side panels.

The set of modular components 500 shown in FIG. 21 is meant to be exemplary. Other sets of modular components 500, including those with less components or those with additional components, are contemplated without departing from the scope of the present disclosure.

It can be seen that the described embodiments provide unique and novel sets of modular bench components and modular bench assemblies that have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A modular outdoor bench assembly comprising:
a first seat component comprising an upper seating surface and an underside, the first seat component spanning between a first end and a second end, and the underside of the first seat component comprising
a plurality of backrest mounting brackets positioned between the first end and the second end, and
an end support mounting bracket positioned at each of the first end and the second end;
a first backrest component configured to be affixed to at least two of the backrest mounting brackets by braces, each brace having a first end that is attachable to a rear face of the first backrest component and a second end that is attachable to one of the backrest mounting brackets.
a first leg component configured to be affixed to the end support mounting bracket positioned at either the first end or the second end of the seat component;
wherein one or more and optionally a plurality of the first seat components, one or more and optionally a plurality of the first backrest components, and one or more and optionally a plurality of the first leg components can be linked together in different positions to create different seating arrangements.

2. The modular outdoor bench assembly of claim 1, further comprising a second backrest component configured to be affixed to at least two of the backrest mounting brackets by braces, each brace having a first end that is attachable to a rear face of the second backrest component and a second end that is attachable to one of the backrest mounting brackets;
wherein the second backrest component has a different length than the first backrest component; and
wherein one or more and optionally a plurality of the first seat components; one or more and optionally a plurality of the first backrest components; one or more and optionally a plurality of the second backrest components; and one or more and optionally a plurality of the first leg components can be linked together in different positions to create different seating arrangements.

3. The modular outdoor bench assembly of claim 2, wherein the first backrest component has a length that is substantially equivalent to the length of the first seat component and the second backrest component has a length that is less than half the length of the first seat component.

4. The modular outdoor bench assembly of claim 1, further comprising a planter component, a table component, or a combination thereof that is configured to be affixed to the first end or the second end of the seat component in place of the first leg component;
wherein one or more and optionally a plurality of the first seat components; one or more and optionally a plurality of the first backrest components; one or more and optionally a plurality of the first leg components; and one or more and optionally a plurality of the planter and/or table components can be linked together in different positions to create different seating arrangements.

5. The modular outdoor bench assembly of claim 4, wherein the planter and/or table component comprises a top surface and a plurality of mounting plates positioned below the top surface, each of the plurality of mounting plates running along a side of the planter and/or table component and being configured to be affixed to an underside of the seat component at the first end or the second end of the seat component.

6. The modular outdoor bench assembly of claim 5, wherein the planter and/or table component has four sides, all of which are configured to be affixed to the first end or the second end of the seat component; optionally wherein the planter and/or table component has a square shape when viewed from above.

7. The modular outdoor bench assembly of claim 4, wherein the top surface comprises a planter top component or a table top component, either one of which may be secured to the plurality of mounting plates by fasteners.

8. The modular outdoor bench assembly of claim 1, wherein each of the first leg components comprises a top surface configured to serve as an armrest and a mounting plate positioned below the top surface and being configured to be affixed to an underside of the seat component at the first end or the second end of the seat component.

9. The modular outdoor bench assembly of claim 1, wherein each of the first leg components is configured to secure the ends of two of the first seat components together.

10. The modular outdoor bench assembly of claim 1, wherein the first backrest component can be mounted to extend along either side of the first seat component; and optionally where the second backrest component, where present, can be mounted to extend along either side of the first seat component.

11. The modular outdoor bench assembly of claim 1, further comprising a second seat component comprising an upper seating surface and an underside, the second seat component spanning between a first end and a second end, and the underside of the second seat component comprising
a plurality of backrest mounting brackets positioned between the first end and the second end, and
an end support mounting bracket positioned at each of the first end and the second end;
wherein the end support mounting bracket of the second seat component is configured to attach to the first leg component in the same manner as the first seat component; and
wherein the second seat component comprises an angular portion between the first and second ends or is made up of two seat components having angled ends that are aligned to form an angled portion.

12. The modular outdoor bench assembly of claim 11, wherein the angular portion forms an angle of about 90 degrees.

13. The modular outdoor bench assembly of claim 11, wherein the angular portion forms an angle of about 120 degrees.

14. The modular outdoor bench assembly of any one of claims 11, wherein one or more and optionally a plurality of the first seat components, one or more and optionally a plurality of the second seat components, one or more and optionally a plurality of the first backrest components, and one or more and optionally a plurality of the first leg components can be linked together in different positions to create different seating arrangements.

15. The modular outdoor bench assembly of claim 1, further comprising an armrest component that is configured to be attached to the first seat component at a midpoint between the first end and the second end.

16. The modular outdoor bench assembly of claim 1, wherein the upper seating surface of the first seat component comprise a plurality of plastic slats, a front face of the first backrest component comprises a plurality of plastic slats, or both.

17. A set of modular outdoor bench components comprising:
a plurality of seat components, each of which comprises an upper seating surface and an underside, each of which spans between a first end and a second end, and the underside of each of which comprises:
a plurality of backrest mounting brackets positioned between the first end and the second end, and
an end support mounting bracket positioned at each of the first end and the second end;
a plurality of backrest components, each of which is configured to be affixed to at least two of the backrest mounting brackets of any of the plurality of seat components by braces, each brace having a first end that is attachable to a rear face of the first backrest component and a second end that is attachable to one of the backrest mounting brackets; and
a plurality of leg components, each of which is configured to be affixed to any of the end support mounting brackets of the seat component.

18. The set of modular outdoor bench components of claim 17, further comprising at least one framework for a table or planter that is configured to be affixed to any of the end support mounting brackets of the seat component.

19. The set of modular outdoor bench components of claim 18, wherein the framework for a table or planter comprises a plurality of frame elements, each of which is substantially identical to each other, and which are configured to be fastened together to form the framework.

20. The set of modular outdoor bench components of claim 18, further comprising a table top component, a planter top component, or a combination thereof, each of which is configured to be secured to a top of the framework for a table or planter to produce a table or planter.
